(19) United States
(12) Patent Application Publication
(10) Pub. No.: US 2025/0025017 A1
(43) Pub. Date: Jan. 23, 2025

(54) SHOE FIXING DEVICE FOR CLOTHES DRYERS

(71) Applicant: Lei LI, Shenzhen (CN)

(72) Inventor: Lei LI, Shenzhen (CN)

(21) Appl. No.: 18/353,199

(22) Filed: Jul. 17, 2023

(51) Int. Cl. A47L 23/20; D06F 95/00; F16B 47/00

(52) U.S. Cl. CPC A47L 23/20; D06F 95/008; F16B 47/00

(57) ABSTRACT

A shoe fixing device for clothes dryers is composed of a base body and multiple suction cup units, wherein ties are disposed on two sides of the base body and form a limit ring on the surface of the base body to fix a shoe to be dried, and the shoe is limited in the base body; and the multiple suction cup units are arranged along the surface of the base body at intervals, and the whole base body can be attached to the side wall of a drum of a clothes dryer through the multiple suction cup units.

### BACKGROUND OF THE INVENTION

### 1. Technical Field

The invention relates to the technical field of components for clothes dryers, in particular to a shoe fixing device for clothes dryers.

### 2. Description of Related Art

Cloth dryers are electric cleaning appliances capable of drying washed clothes by instantly evaporating water in the washed clothes by means of electrical heating. The clothes dryers not only can dry clothes, but also can dry washed shoes. When placed in the clothes dryers, shoes need to be fixed to be prevented from colliding with the inner wall of the drum of the cloth dryers during the rotation process of the drum, which may otherwise produce loud noise and cause damage to shoes.

At present, there are two common devices for fixing shoes in the drum of clothes dryers. One of the devices is a holder disposed in the clothes dryer and is fixed in a special socket of the clothes dryer, washed shoes are fixed on the holder in use, and in this case, the shoes to be dried cannot rotate with the drum of the clothes dryer. The other one is a universal string bag, washed shoes are placed in the string bag, then the string bag is tied on the door of the clothes dryer, and in this case, the washed shoes cannot rotate along with the drum either, so the drying efficiency is low.

Therefore, it becomes an issue to be settled to develop a novel shoe fixing device to solve the abovementioned problems.

### BRIEF SUMMARY OF THE INVENTION

In view of this, the invention provides a shoe fixing device for clothes dryers to solve the problems that, in the prior art, the drying efficiency is low because shoes cannot rotate with the drum of clothes dryers when dried in the clothes dryers.

The technical solution provided by the invention is specifically as follows: a shoe fixing device for clothes dryers comprises a base body and multiple suction cup units;

The base body is used for carrying shoes, one or more groups of ties are disposed on side faces of the base body, each group of ties comprises a first tie and a second tie, and the first tie and the second tie each have a connecting end and a fixing end;

The connecting end of the first tie is integrally connected to one side of the base body;

The connecting end of the second tie is integrally connected to the other side of the base body, and the second tie is symmetric with the first tie; when the free end of the first tie is connected to the free end of the second tie, a limit ring is formed on a surface of the base body to fix and limit the shoes;

The multiple suction cup units are arranged along an outer surface of the base body at intervals, and each of the suction cup units is fixedly connected to the base body.

Preferably, the base body is identical in shape with a sole of the shoes, and comprises a sole part and a heel part which are connected integrally.

Further preferably, two groups of ties are disposed on the two sides of the base body respectively, wherein one group of ties are located on two sides of the sole part of the base body, and the other group of ties are located on two sides of the heel part of the base body.

Further preferably, the base body and the ties are made of soft materials and are formed integrally.

Further preferably, the free end of the first tie and the free end of the second tie are connected through a buckle or a hook-and-loop fastener, or are tied together.

Further preferably, protrusions are disposed on an inner surface of the base body at intervals.

The shoe fixing device for clothes dryers is composed of a base body and multiple suction cup units, wherein ties are disposed on two sides of the base body and form a limit ring on the surface of the base body to fix a shoe to be dried, and the shoe is limited in the base body; the multiple suction cup units are arranged along the surface of the base body at intervals, and the whole base body can be attached to the side wall of a drum of a clothes dryer through the multiple suction cup units; and when the shoe is dried, the base body and the shoe are limited on the side wall of the drum, and thus can rotate along with the drum of the clothes dryer and will not turn and collide with the drum, such that the drying efficiency is improved.

The shoe fixing device for clothes dryers has the advantages of being simple in structure, reasonable in design, convenient to use, high in drying efficiency, and the like.

It should be understood that the general description above and the detailed description below are merely illustrative and explanatory, and should not be construed as limitations of the invention.

### BRIEF DESCRIPTION OF THE SEVERAL VIEWS OF THE DRAWINGS

The drawings are incorporated into the specification as one part of the specification, illustrate some embodiments of the invention, and are used to explain the principle of the invention together with the specification.

To more clearly describe the technical solutions of the embodiments of the invention or the prior art, the drawings used for describing the embodiments of the invention or the prior art are briefly introduced below. Obviously, those ordinarily skilled in the art can obtain other drawings according to the following ones without creative labor.

FIG. 1 is a structural diagram of an outer side of a shoe fixing device for clothes dryers according to one embodiment of the invention;

FIG. 2 is a structural diagram of an inner side of the shoe fixing device for clothes dryers according to one embodiment of the invention;

FIG. 3 is a structural diagram of the shoe fixing device for clothes dryers when the shoe fixing device is used for limiting shoes according to one embodiment of the invention.

### DETAILED DESCRIPTION OF THE INVENTION

The invention will be described in detail below with reference to the accompanying drawings and embodiments. These embodiments are provided for the purpose of explaining the invention rather than limiting the invention. As a matter of fact, those skilled in the art should understand that modifications and transformations can be made to the invention without deviating from the scope or spirit of the invention. For example, a feature illustrated or described in one embodiment can be applied to another embodiment to generate a new embodiment. Therefore, the invention is expected to include all modifications and transformations made within the scope of the appended claims and their equivalents.

In the description of the invention, terms such as “lengthwise”, “crosswise”, “upper”, “lower”, “front”, “back”, “left”, “right”, “vertical”, “horizontal”, “top” and “bottom” are used to indicate directional or positional relationships based on the accompanying drawings merely for the purpose of describing the invention, and do not require that the invention must be configured and operated in a specific direction, and thus, they should not be construed as limitations of the invention. Terms used in the invention such as “join”, “connect” and “dispose” should be broadly understood. For example, “connect” may refer to fixed connection or detachable connection; or, direct connection, or indirect connection through an intermediate component; or, wired electrical connection, wireless electrical connection, or wireless connection through communication signals, and those ordinarily skilled in the art can appreciate the specific meaning of these terms as the case may be.

One or more examples are illustrated in the accompanying drawings. Numerical and alphabetic reference signs are used in the detailed description to represent features in the accompanying drawings. Identical or similar reference signs in the accompanying drawings and description represent identical or similar parts of the invention. As used in the specification, terms “first”, “second” and “third” can be used interchangeably to distinguish one component from another, and are not intended to represent the position or importance of components.

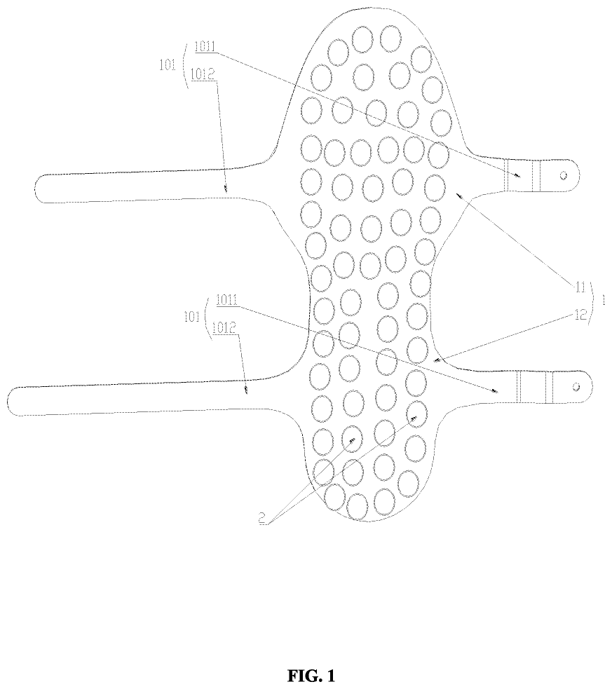

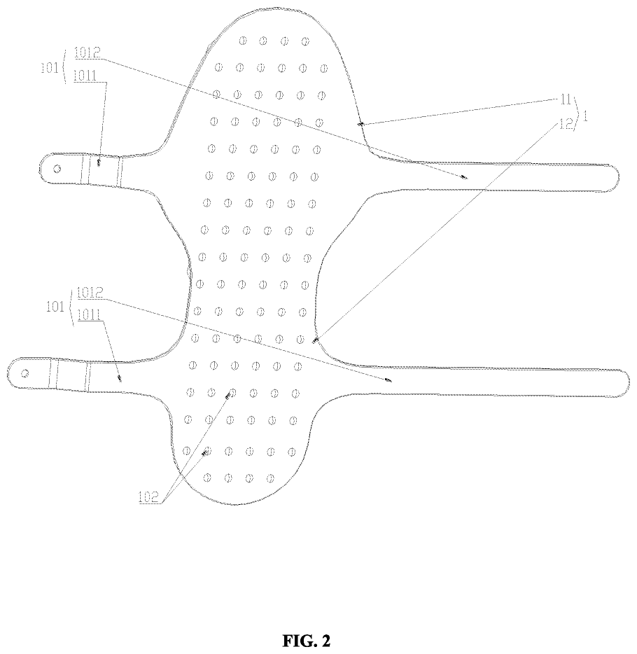

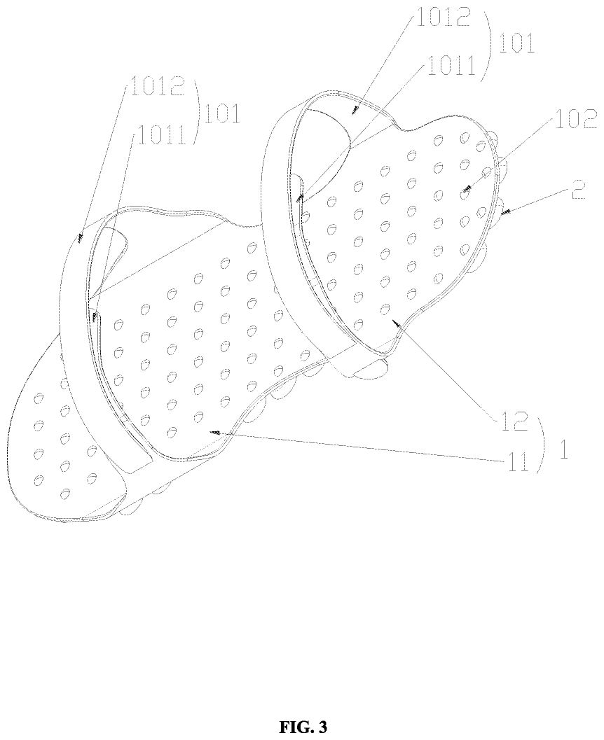

To solve the problem that, in the prior art, the drying efficiency is low because shoes cannot rotate along with the drum of clothes dryers when dried in the clothes dryers, this embodiment provides a shoe fixing device for clothes dryers. As shown in FIG. 1 and FIG. 2, the shoe fixing device is mainly composed of a base body 1 and multiple suction cup units 2, wherein the base body 1 is used for carrying shoes, and one or more groups of ties 101 are disposed on side faces of the base body 1; each group of ties 101 comprises a first tie 1011 and a second tie 1012, the first tie 1011 and the second tie 1012 each have a connecting end and a free end, the connecting end of the first tie 1011 is integrally connected to one side of the base body 1, the connecting end of the second tie 1012 is integrally connected to the other side of the base body 1, and the second tie 1012 is symmetric with the first tie 1011; and as shown in FIG. 3, when the free end of the first tie 1011 is connected to the free end of the second tie 1012, a limit ring is formed on the surface of the base body 1 to fix and limit shoes, such that the shoes are fixed on the base body 1. The multiple suction cup units 2 are arranged along an outer surface of the base body 1 at intervals, and each suction cup unit 2 is fixedly connected to the base body 1 and is used for fixing the base body 1 on a side wall of a drum of a clothes dryer.

When the shoe fixing device is used, a shoe to be dried is placed on the base body, with the sole of the shoe being connected to the base body; then, the free end of the first tie and the free end of the second tie are connected according to the height of the shoe; next, the shoe to be dried is tied on the base body through the first tie and the second tie, such that the position of the shoe on the base body is fixed; then, the base body and the shoe in the base body are attached to the side wall of the drum of the clothes dryer through the multiple suction cup units fixed on the base body, such that the position of the shoe on the side wall of the drum is fixed. In this way, when the clothes dryer is started to dry the shoe, the shoe is wrapped in the base body and will rotate along with the drum, such that the drying efficiency is improved.

Due to the fact that the shoe fixing device is mainly used for fixing the position of shoes when the shoes are dried in the dryer, the base body 1 is designed to be identical in shape with the sole of shoes, and comprises a sole part 11 and a heel part 12 which are connected integrally, as shown in FIG. 1 and FIG. 2.

The number of ties 101 on the two sides of the base body 1 can be set freely as actually needed. When the fixing device is used for fixing shoes, as shown in FIG. 1 and FIG. 2, two groups of ties 101 are disposed on the two sides of the base body 1, wherein one group of ties 101 are located on two sides of the sole part 11 of the base body 1, the other group of ties 101 are located on two sides of the heel part 12 of the base body 1, and shoes can be fixed through the two groups of ties on the sole part 11 and the heel part 12.

Preferably, the base body 1 and the ties 101 of the shoe fixing device are made of soft materials and are formed integrally. For example, the base body 1 and the ties 101 may be made of rubber, canvas, soft plastic, or other soft materials. The free end of the first tie 1011 and the free end of the second tie 1012 in each group of ties 101 may be connected in various manners as long as the free end of the first tie 1011 and the free end of the second tie 1012 can be fixedly connected. For example, the free end of the first tie 1011 and the free end of the second tie 1012 are connected through a buckle or a hook-and-loop fastener, or are directly tied together.

To increase the friction coefficient of the base plate and the bottom of shoes, as a further improvement of the technical solution, as shown in FIG. 2, protrusions are disposed on an inner surface of the base body at intervals to make the contact surface between the sole of the shoes and the base body uneven, such that the frictional force between the sole and the base body is improved, the shoes can be fixed on the base body more firmly and will not fall accidentally during the rotational drying process. Wherein, the protrusions may be triangular, oval, square, circular, or in other shapes.

Those skilled in the art can easily obtain other implementations of the invention after thinking over and implementing the invention disclosed here. The application intends to include any transformations, uses or adaptive modifications of the invention, and these transformations, uses or adaptive modifications follow the general principle of the invention and include common sense or technical means, not disclosed by the disclosure, in the art. The specification and embodiments are merely illustrative, and the scope and spirit of the invention should be defined by the appended claims.

It should be understood that the invention is not limited to the accurate structures which have been described above and shown in the drawings, and various modifications and transformations can be made without deviating from the scope of the invention. The scope of the invention should be defined by the appended claims.

The above embodiments are merely preferred ones of the invention, and are not used to limit the invention, and for those skilled in the art, various modifications and changes can be made to the invention. Any amendments, equivalent substitutions and improvements made based on the spirit and principle of the invention should fall within the protection scope of the invention.

What is claimed is:

1. A shoe fixing device for clothes dryers, comprising: a base body and multiple suction cup units, wherein:
the base body is used for carrying shoes, one or more groups of ties are disposed on side faces of the base body, each group of ties comprises a first tie and a second tie, and the first tie and the second tie each have a connecting end and a fixing end;
the connecting end of the first tie is integrally connected to one side of the base body;
the connecting end of the second tie is integrally connected to the other side of the base body, and the second tie is symmetric with the first tie; when the free end of the first tie is connected to the free end of the second tie, a limit ring is formed on a surface of the base body to fix and limit the shoes;
the multiple suction cup units are arranged along an outer surface of the base body at intervals, and each of the suction cup units is fixedly connected to the base body.

2. The shoe fixing device for clothes dryers according to claim 1, wherein the base body is identical in shape with a sole of the shoes, and comprises a sole part and a heel part which are connected integrally.

3. The shoe fixing device for clothes dryers according to claim 2, wherein two groups of ties are disposed on the two sides of the base body respectively, wherein one group of ties are located on two sides of the sole part of the base body, and the other group of ties are located on two sides of the heel part of the base body.

4. The shoe fixing device for clothes dryers according to claim 1, wherein the base body and the ties are made of soft materials and are formed integrally.

5. The shoe fixing device for clothes dryers according to claim 1, wherein the free end of the first tie and the free end of the second tie are connected through a buckle or a hook-and-loop fastener, or are tied together.

6. The shoe fixing device for clothes dryers according to claim 1, wherein protrusions are disposed on an inner surface of the base body at intervals.
